(19) United States
(12) Patent Application Publication
(10) Pub. No.: US 2011/0320765 A1
(43) Pub. Date: Dec. 29, 2011

(54) VARIABLE WIDTH VECTOR INSTRUCTION PROCESSOR

(75) Inventors: Tejas Karkhanis, White Plains, NY (US); Jose E. Moreira, Irvington, NY (US); Valentina Salapura, Chappaqua, NY (US)

(73) Assignee: International Business Machines Corporation, Armonk, NY (US)

(21) Appl. No.: 12/825,328

(22) Filed: Jun. 28, 2010

(51) Int. Cl. G06F 9/30; G06F 15/76

(52) U.S. Cl. 712/7; 712/E09.016

(57) ABSTRACT

A computer processor, method, and computer program product for executing vector processing instructions on a variable width vector register file. An example embodiment is a computer processor that includes an instruction execution unit coupled to a variable width vector register file which contains a number of vector registers, the width of the vector registers is changeable during operation of the computer processor.

### BACKGROUND

The present invention relates generally to a computer processors, and more particularly to a variable width vector instruction processor.

Vector processing instructions operate on one-dimensional arrays of data called vectors. Each vector contains multiple data items which can be manipulated in parallel by the vector processing instruction, thus increasing computer efficiency. This is in contrast to a scalar instruction which operates on a single data item.

For example, a single vector addition operation on two vectors, the first of which contains the numbers 10, 11, and 12 and the second of which contains the numbers 3, 5, and 7, may call for each corresponding pair from the two vectors (10 and 3, 11 and 5, 12 and 7) to be added, resulting in a vector containing the numbers 13, 16, and 19. Thus, three additions are done by a single vector instruction in parallel. In contrast, three separate scalar instructions are typically required to add the same three pairs from the example above. Typically, the same vector instruction (addition in the example above) is applied to all data elements in the vectors, an approach that is known as single instruction multiple data (SIMD) computing.

The data vectors on which vector processing instructions operate may be stored in vector registers. These vector registers can be specialized computer memory circuits that are integrated in the computer processor and accessed faster than the rest of the memory in the computer. In some architectures (known as load-store architectures), vector instructions can operate only on data in vector registers, thus processing a vector instruction may require first loading the vector data elements into one or more vector registers. Typically, such architectures are utilized in reduced instruction set (RISC) computers.

### BRIEF SUMMARY OF INVENTION

An example embodiment of the present invention is a computer processor that includes a variable width vector register file containing a number of vector registers. The width of the vector registers is dynamically changeable during operation of the computer processor. The computer processor also includes an instruction execution unit coupled to the variable width vector register file and configured to access the vector registers in the vector register file.

Another example embodiment of the invention is a method for executing a vector processing instruction by an instruction execution unit coupled to a variable width vector register file in a computer processor. The method includes a receiving step where the vector processing instruction to be executed is received by the instruction execution unit. Another receiving step in the method involves receiving a register width value that indicates a necessary width of the vector registers in the vector register file in order to perform the vector processing instruction. The method also involves accessing a portion of the vector registers in the vector register file based on the received register width value. Another step in the method involves processing the received vector processing instruction based on the received register width value and the accessed vector registers.

Yet another example embodiment of the invention is a computer program product for executing a vector processing instruction on a variable width vector register file in a computer processor. The computer program product includes computer readable program code configured to receive the vector processing instruction, receive a register width value indicating a necessary width of the vector registers in the vector register file in order to perform the vector processing instruction, access a portion of the vector registers in the vector register file based on the received register width value, and process the received vector processing instruction based on the received register width value and the accessed vector registers.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an example computer processor for executing vector processing instructions on a variable width vector register file as contemplated by an embodiment of the present invention.

FIG. 2 shows the computer processor embodiment from FIG. 1 configured to support a single execution thread utilizing the maximum width of the variable width vector register file.

FIG. 3 shows the computer processor embodiment from FIG. 1 configured to support two execution threads.

FIG. 4 shows the computer processor embodiment from FIG. 1 configured to support four execution threads.

FIG. 5 shows the computer processor embodiment from FIG. 1 configured to support eight execution threads.

FIG. 6 shows an example method for executing a vector processing instruction on a variable width vector register file, as contemplated by an embodiment of the present invention.

### DETAILED DESCRIPTION

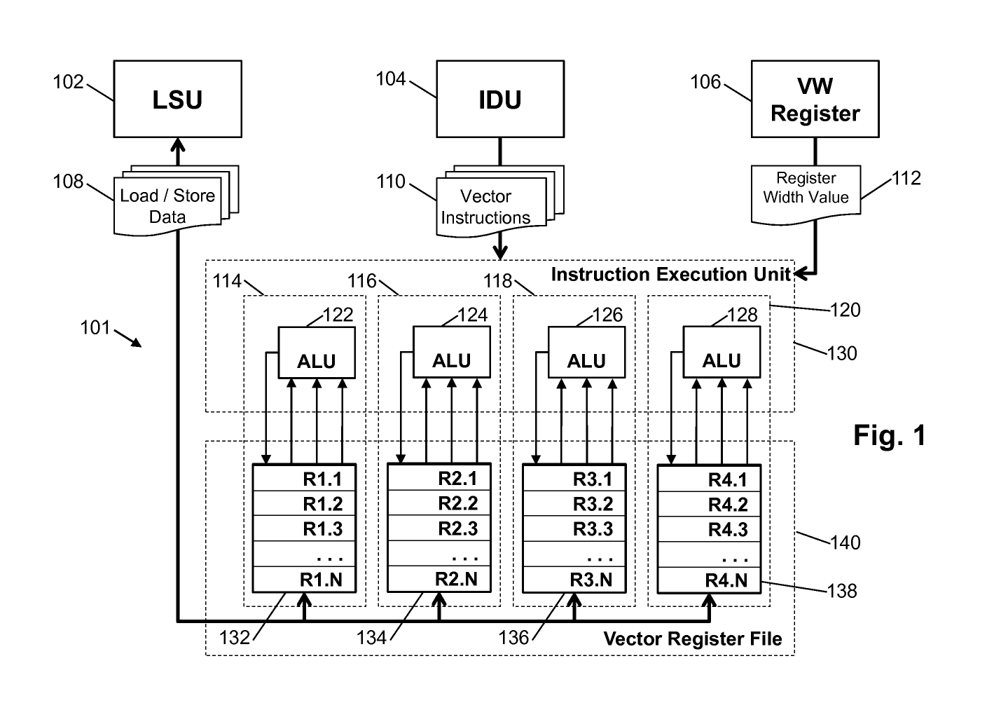

The present invention is described with reference to embodiments of the invention. Throughout the description of the invention reference is made to FIGS. 1-6.

FIG. 1 illustrates a computer processor incorporating an embodiment of the present invention. It is noted that the computer processor shown in FIG. 1 is just one example of various arrangements of the present invention and should not be interpreted as limiting the invention to any particular configuration.

The computer processor may include a vector-scalar unit (VSU) 101 capable of executing vector processing instructions on vector registers of variable width. In particular, the VSU may be integrated in a processor core of a central processing unit (CPU) of a computer. Furthermore, the CPU core may be capable of executing multiple threads.

The computer processor presented in FIG. 1 includes a variable width vector register file 140 that contains a plurality of vector registers of a particular bit width, the bit width of the vector registers is dynamically changeable during operation of the computer processor. Typically, a vector register contains multiple data elements, the number of elements contained in the vector register is dependent on the bit width of the register and the type of the elements. For example, a vector register that is 128 bits wide may contain 16 character elements that are 8 bits each, or it may contain 8 integer elements that are 16 bits each. Thus, the number of data elements of a given type that can be stored in a particular register of the variable width vector register file 140 may change during operation of the computer processor as the bit width of the vector register changes. In one embodiment of the invention, the correct number of data elements in a vector register of the variable width vector register file 140 can be accessed by specifying a register identifier and a necessary vector register width. For example, one may address the first vector register of width 128 bits, or one may address the second vector register of width 256 bits.

Coupled to the variable width vector register file 140 in FIG. 1 is an instruction execution unit 130 that is configured to access the vector registers contained in the vector register file 140. The instruction execution unit 130 is configured to receive vector processing instructions 110 and process them based on a portion of the vector registers in the vector register file 140. The instruction execution unit 130 may further write results of the processing of the received instructions 110 to the portion of the vector registers in the vector register file 140. The instruction execution unit 130 may also contain multiple execution pipelines and thus may be able to execute instructions from different execution threads in parallel. As already mentioned, in one embodiment of the invention, the instruction execution unit 130 would typically need to supply a necessary register width value to access the desired portion of the vector register file 140.

The vector processing instructions 110 received by the instruction execution unit 130 are configured to receive a register width value 112 that indicates a necessary width of the vector registers contained in the vector register file 140 in order to perform the vector processing instructions. In general, vector processing instructions involve arithmetic or logical operations on individual data elements in one or more vector registers. Each instruction identifies the operation to be performed, what vector registers it needs to be performed on, and the type of the data elements in the vector registers. For example, an integer addition vector instruction may call for each integer element in a vector register to be added to a corresponding integer element in another vector register and the result stored in a corresponding integer element of a third vector register.

Since the number of data elements in the variable width vector registers of the embodiment in FIG. 1 can dynamically change, each vector processing instruction 110 is set up to require a necessary bit width to specify how many operations need to be performed. Thus, the same set of vector instructions 110 may be processed by the instruction execution unit 130 on vector registers of variable width by supplying the necessary register width as the instructions are executed. For example, the instruction execution unit 130 may receive the necessary register width 112 together with each received vector processing instruction 110 and then supply the received register width 112 to execute the received vector processing instruction.

In one embodiment of the invention, the instruction execution unit 130 in FIG. 1 is configured to receive the necessary register width value 112 from a vector width register 106. For example, the instruction execution unit 130 may be coupled to the vector width register 106 so as to read the necessary register width value 112 whenever it receives and executes a vector processing instruction 110 and whenever it needs to access a portion of the variable width vector registers in the vector register file 140.

In one embodiment, the register width value 112 stored in the vector width register 106 may be dynamically changeable during operation of the computer processor, so as to attempt maximum computational throughput. For example, the register width value 112 in the vector width register 106 may be computed as a function of the number of currently active execution threads that send vector processing instructions 110 to the instruction execution unit 130. Typically, a single thread may thus execute vector processing instructions on wide vector registers that contain many data elements in order to maximize data parallelism. Alternatively, multiple threads may execute vector processing instructions in parallel on narrow vector registers that contain few data elements in order to maximize thread parallelism.

In one embodiment of the invention, the variable width vector registers in the vector register file 140 are comprised of one or more fixed width vector registers. The precise number of fixed width vector registers that are combined to form each variable width vector register in the vector register file 140 may be dynamically changed during operation of the computer processor. Thus, the bit width of the variable width vector registers in the vector register file 140 varies with the number of fixed width vector registers that are included in each variable width vector register.

In one embodiment, the instruction execution unit 130 accesses the registers in the vector register file 140 by utilizing a plurality of single-instruction-multiple data (SIMD) arithmetic-logic units (ALUs) 122, 124, 126, and 128. Each ALU is coupled to a subset of the fixed width vector registers that are combined to form the variable width vector registers in the vector register file. Each ALU is also configured to receive data from the subset of fixed width vector registers, perform arithmetic and logical functions upon the received data, and store results from the arithmetic and logical functions in the subset of fixed width vector registers. Thus, the instruction execution unit 130 can perform arithmetic and logical operations on the variable width vector registers in the vector register file 140 by identifying and utilizing the ALUs that are coupled to their component fixed width vector registers.

The VSU 101 includes a variable width vector register file 140 and an instruction execution unit 130 coupled to the variable width vector register file 140 to receive data from the register file, perform arithmetic and logical functions upon the received data, and store results from the arithmetic and logical functions in the register file.

The variable width vector register file 140 and the arithmetic and logical functionality of the instruction execution unit 130 may be implemented via a plurality of potentially identical building blocks 114, 116, 118, and 120. Each of the building blocks 114, 116, 118, and 120 includes a fixed width register file 132, 134, 136, and 138 with N entries of vector registers (labeled R1.1 through R4.N in each of the fixed width register files 132, 134, 136, and 138) of a particular bit width (for example 128 bits). Each of the fixed width register files 132, 134, 136, and 138 has four read ports (allowing up to four of its vector registers to be read at a time) and two write ports (allowing data to be written in up to two of its vector registers at a time).

Each building block 114, 116, 118, and 120 in FIG. 1 also includes a single instruction multiple data (SIMD) arithmetic logic unit (ALU) 122, 124, 126, and 128 coupled to the respective vector register file 132, 134, 136, and 138 in the building block. Each of the ALUs 122, 124, 126, and 128 has bit width equal to the bit width of the register files 132, 134, 136, and 138. Each of the ALUs 122, 124, 126, and 128 is coupled to the respective register file 132, 134, 136, and 138 in its building block via three read ports and one write port. Thus, each of the ALUs 122, 124, 126, and 128 can perform a single vector processing instruction with three operands (like the vector multiply-add operation R1.4=R1.1*R1.2+R1.3) on any three of the vector registers in the vector register file 132, 134, 136, and 138 to which it is coupled. Furthermore, the ALU can simultaneously store the result of the operation back to the vector register file to which it is coupled.

As mentioned, the VSU 101 may be integrated in a CPU core. Each of the fixed width vector register files 132, 134, 136, and 138 that are included in the variable width vector register file 140 is coupled with the load store unit (LSU) 102 of the CPU core via one read port and one write port. Thus, the LSU can simultaneously load and store data 108 to two of the registers R1.1 through R4.N in the fixed width vector register files 132, 134, 136, and 138.

The instruction execution unit 130 of the VSU 101 is coupled to the instruction dispatch unit (IDU) 104 of the CPU core. The IDU 104 of the computer processor core recognizes vector processing instructions and forwards them to the instruction execution unit 130 of the VSU for processing. In one embodiment of the invention, the IDU is able to dispatch instructions from different threads in the same processor cycle. Also, the instruction execution unit 130 may contain multiple execution pipelines that can perform vector processing instructions from different threads concurrently by utilizing separate ALUs 122, 124, 126, and 128.

The variable width nature of the VSU vector register file 140 may be realized by dynamically combining its component fixed width vector register files 132, 134, 136, and 138. The strategy used is to dynamically set the vector width of the resulting combined vector registers so as to ensure maximum computational throughput for the number of threads that are dispatching vector processing instructions to the VSU 101. As discussed, the necessary vector register width value 112 can be stored in a vector width register 106 from where the instruction execution unit 130 may read it and use it when executing vector processing instructions 110 and accessing the variable width vector register file 140.

There may be one vector width register per CPU core in which the VSU is integrated, with the vector width register shared between the CPU core and the VSU 101. Further, the vector register width value 112 in the vector width register 106 may be set by the entity that controls the number of concurrent threads executing in the CPU core. Typically, that is the hypervisor that controls the virtual machines in the CPU or the operating system that runs on the CPU.

One possible way to combine two or more of the fixed width vector register files 132, 134, 136, and 138 in FIG. 1 in order to build a larger vector register file is to synchronize the rename maps for the combined fixed width vector register files so they have the same contents during each cycle when instructions are executed by the VSU 101. Typically a rename map contains mappings to translate architected vector registers that are referenced by the vector processing instructions (for example, registers A, B, C, etc.) to the implemented vector registers that are actually used by the computer processor to store the vector register values (for example, registers R1.1, R1.2, R1.3, etc. in FIG. 1). Thus, the vector processing instructions 110 typically refer to the architected registers and the computer processor (consisting of the instruction execution unit 130 and the vector register file 140) uses the rename map to translate those architected registers to implemented registers (R1.1 through R4.N) on which the vector processing instructions are carried out. For example, a vector processing instruction may call for adding vector registers A and B and storing the result in vector register C while the computer processor translates those to the implemented registers and in actuality adds vector registers R1.1 and R1.2 and stores the result in vector register R1.3.

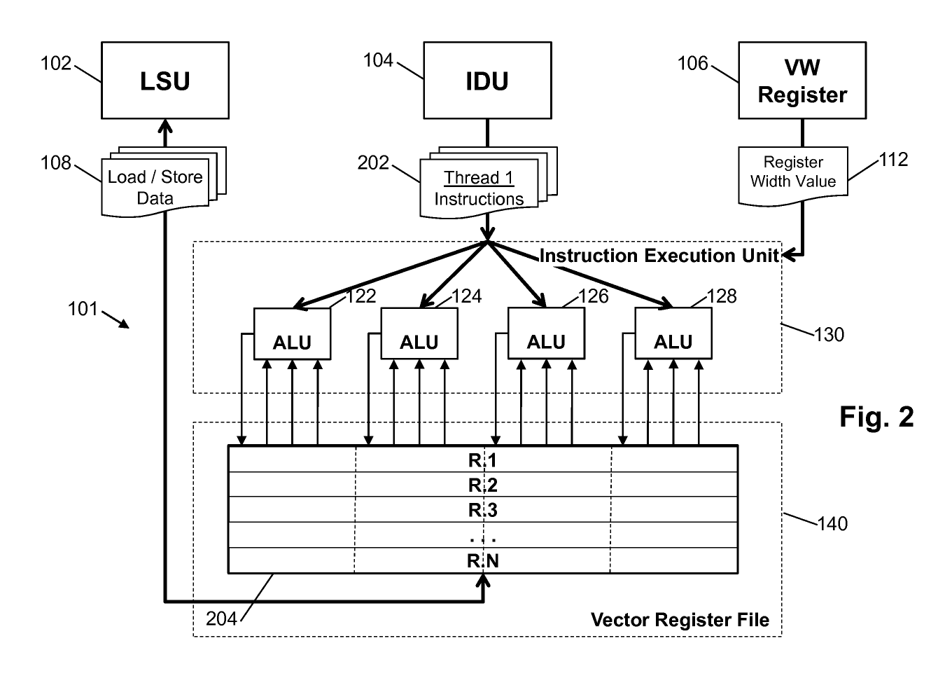

Synchronizing the rename maps of two or more of the fixed width vector register files 132, 134, 136, and 138 in FIG. 1 so as to combine them in a larger vector register file can be done by implementing a separate rename map for each building block 114, 116, 118, and 120, and setting up the rename maps for the two or more building blocks that are combined so they contain the same mappings. For example, if we want to combine blocks 114 and 116, the rename maps of the two blocks may be synchronized so that architected vector register A maps to implemented vector register R1.1 in block 114 and to R2.1 in block 116, architected vector register B maps to implemented vector register R1.2 in block 114 and to R2.2 in block 116, etc. Thus, whenever a vector processing instruction is executed that accesses architected vector register A, both the underlying implemented vector registers R1.1 and R2.1 will be accessed in parallel by their corresponding coupled ALUs 122 and 124, in effect combining the two fixed width vector registers. This concept is further illustrated in FIG. 2 through 5 with different combinations of building blocks as dictated by the register width value 112.

FIG. 2 illustrates the VSU 101 implementation from FIG. 1 when a single thread is running in the CPU core and is sending vector processing instructions 202 to the VSU. Assuming that the bit width of each of the fixed width vector registers 132, 134, 136, and 138 in building blocks 114, 116, 118, and 120 in FIG. 1 is 128 bits, for example, the vector register width value 112 in the vector width register 106 may be set to 512 bits to denote that all building blocks 114, 116, 118, and 120 need to be utilized to process the vector instructions 202 from the single thread. Thus, the instruction execution unit 130 can synchronize the rename maps of all building blocks in the VSU and can send each of the vector processing instructions 202 to all 4 ALUs 122, 124, 126, and 128.

Furthermore, since the rename maps of all the building blocks have the same mappings, each ALU will change the same registers in the fixed width vector register files 132, 134, 136, and 138 from FIG. 1, thus in effect combining them into a single vector register file 204 in FIG. 2. For example, since vector registers R1.1, R2.1, R3.1, and R4.1 in FIG. 1 will be changed in parallel by ALUs 122, 124, 126, and 128, they are effectively combined into vector register R.1 in FIG. 2. As described before, the vector processing instructions 202 are independent of the actual vector register width as it is supplied when they are executed. Also, the full capacity of the variable width vector register file 140 is dedicated to the single running thread, thus maximizing data parallelism.

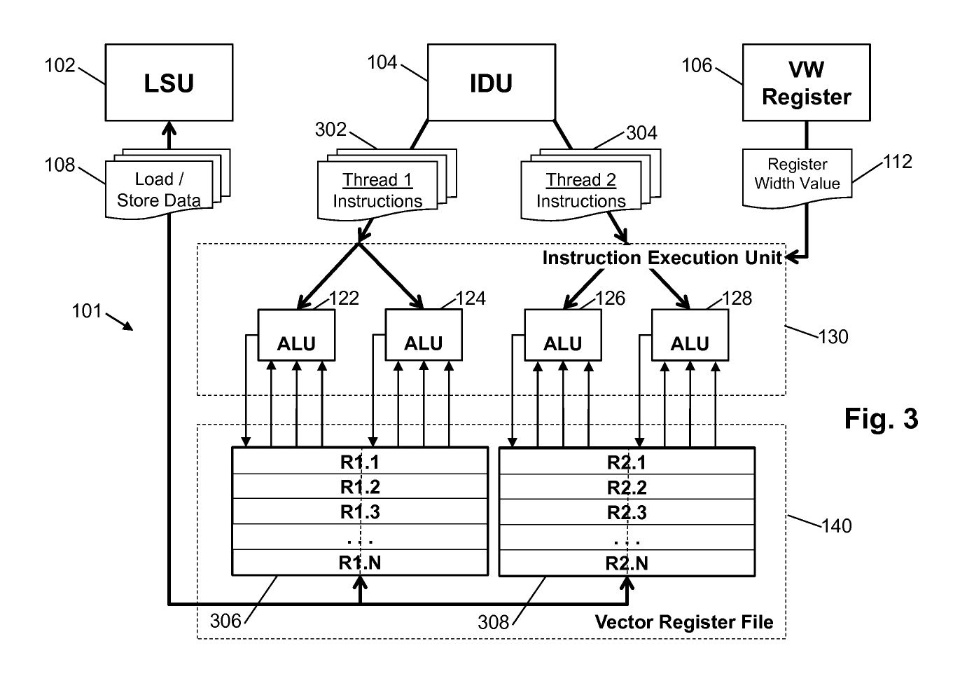

FIG. 3 illustrates the VSU 101 implementation from FIG. 1 when two threads are running in the CPU core and each thread sends vector processing instructions 302 and 304 to the VSU. Again, assuming that the bit width of each of the fixed width vector registers 132, 134, 136, and 138 in building blocks 114, 116, 118, and 120 in FIG. 1 is 128 bits, the vector register width value 112 in the vector width register 106 may be set to 256 bits to denote that half of the building blocks 114, 116, 118, and 120 need to be utilized to process the vector instructions from each thread. Thus, the instruction execution unit 130 can synchronize the rename maps of building blocks 114 and 116 and the rename maps of building blocks 118 and 120. Also, the instruction execution unit 130 can send the vector processing instructions 302 from Thread 1 to ALUs 122 and 124 and the vector processing instructions 304 from Thread 2 to ALUs 126 and 128.

Again, since the rename maps of the building blocks within each pair 114/116 and 118/120 have the same mappings, ALUs combined within each pair will change the same registers in the fixed width vector register files 132/134 and 136/138 from FIG. 1, thus in effect combining them into two separate vector register files 306 and 308 in FIG. 3. Under this approach, the capacity of the variable width register file 140 is evenly split between the two active threads that send vector processing instructions 302 and 304 to the VSU.

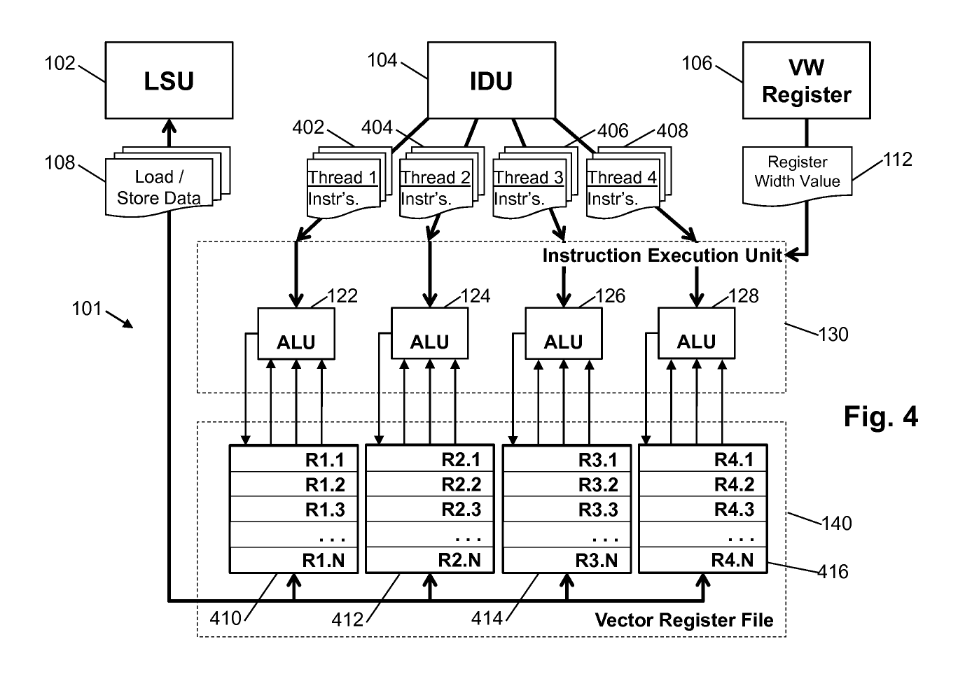

FIG. 4 shows the VSU 101 implementation of FIG. 1 when four threads are active in the CPU core and send vector processing instructions to the VSU. Here the vector register width value 112 in the vector width register 106 can be set to the width of the fixed vector registers 132, 134, 136, and 138 from FIG. 1 to denote that each fixed width vector register should be used independently. Thus, the instruction execution unit 130 can keep the rename maps of building blocks 114, 116, 118, and 120 from FIG. 1 independent and can send vector processing instructions 402, 404, 406, and 408 from each of the four threads to ALUs 122, 124, 126, and 128 respectively.

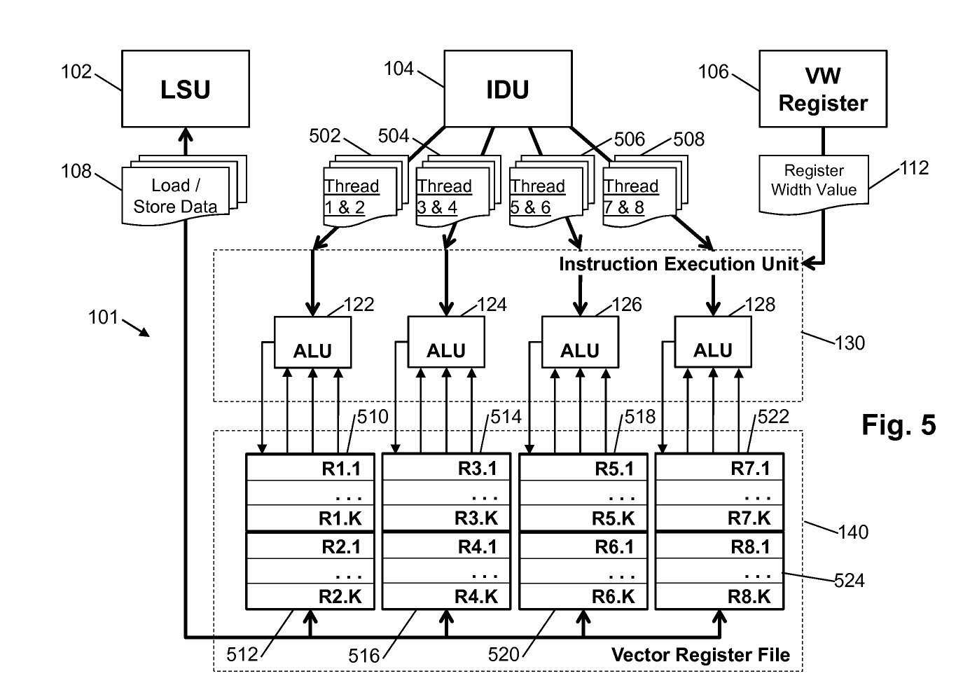

FIG. 5 illustrates the VSU 101 implementation from FIG. 1 when more threads are running in the CPU core (eight in the example in FIG. 5) than there are building blocks in the VSU (four in the examples in FIGS. 1-5). Similarly to FIG. 4, the register width value 112 is set to the width of the fixed vector registers 132, 134, 136, and 138 from FIG. 1 to denote that each fixed width vector register should be used independently. To be able to process all eight threads in parallel, however, the instruction execution unit 130 can share each ALU between two threads. Thus, the instruction execution unit can utilize ALU 122 to process instructions 502 from Threads 1 and 2, ALU 124 to process instructions 504 from Threads 3 and 4, etc. Furthermore, the rename maps of each block can be set up so that the implemented registers R1.1 through R4.N from FIG. 1 are shared among all eight threads. Thus, vector registers R1.1 through R1.K in FIG. 5 (which may be exactly half of registers R1.1 through R1.N in FIG. 1) are utilized for Thread 1, registers R2.1 through R2.K are utilized for Thread 2, etc.

It should be noted that the register width value 112 stored into the vector width register 106 need not be a bit width value. Any value that can be used to calculate a multiple of the fixed width vector register files 132, 134, 136, and 138 that needs to be combined into a larger vector register can be used. For example, assuming that the fixed width vector registers are 128 bits wide, a register width value of 256 may be used to indicate that two 128 bit registers need to be combined or a register width value of 2 may be used to similarly indicate that two registers need to be combined.

The VSU is responsible for providing the hardware logic that extracts high performance from the vector code without burdening the programmer to tune vector code for a specific hardware. As disused above, the configurations from FIGS. 1-5 may be controlled through a system register for vector width called the VW register. In one embodiment, there is one VW register for every core and it is controlled by the entity that controls the threading mode of the core (hypervisor or operating system). The width of the vector depends on the threading mode. The programmer is oblivious to the threading mode and writes the code in vector-width independent manner.

A high level illustration of writing vector width independent code is given by the following example of daxpy:

for (int i=0; i<n; i++)
y[i] = a*x[i] + y[i];

A vector-width independent version of the daxpy code is given below:

```
{
  int i;
  for (i=0; i<n−VW+1; i+=VW)
    for (int j=i; j<i+VW; j++)
      y[j] = a*x[j] + y[j];
  for (; i<n; i++)
    y[i] = a*x[i]+y[i];
}
```

In the above vector width-independent code, the inner for loop (highlighted in bold) is one vector operation that can be implemented by four vector instruction (two loads, one fma, one store). The second for loop is a scalar loop that processes residual data when the amount of data is not evenly divisible by the vector register width. The number of vector instructions executed is a function of the vector width specified in the VW register. For larger VW, there are fewer vector instructions; for smaller VW, there are more vector instructions.

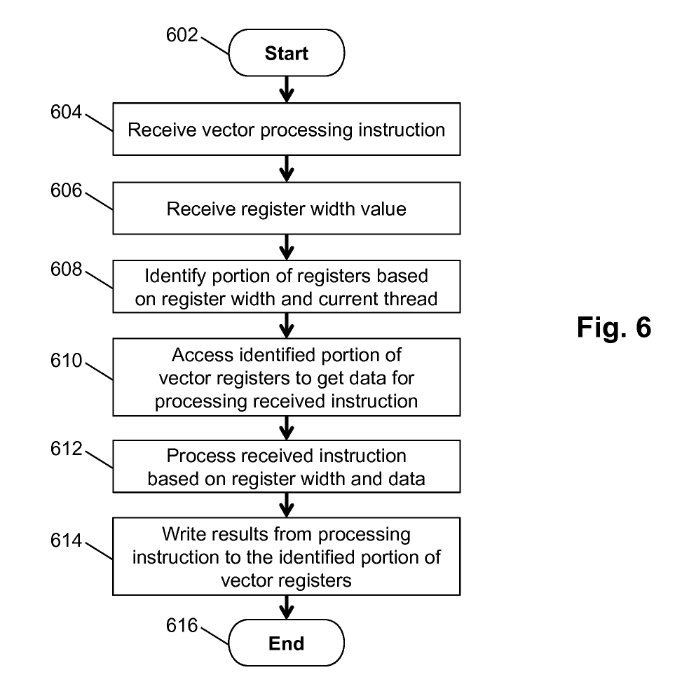

FIG. 6 illustrates another embodiment of the present invention as a method for executing a vector processing instruction by an instruction execution unit coupled to a variable width vector register file in a computer processor. The method begins at block 602 and the first step illustrated in block 604 includes receiving a vector processing instruction. As discussed above, the same set of vector processing instructions may be used to work with vector registers of variable width. Thus, the received vector processing instruction may identify the type of operation to perform, the vector registers to perform the operation on, and the type of the data elements in the vector registers. The vector processing instruction need not identify a necessary vector register width for its execution.

Once block 604 is completed, control passes to block 606 where the register width necessary to process the instruction is received. As previously mentioned, the register width value may be read from a vector width register as each instruction is received by the step in block 604. Furthermore, the register width value may dynamically change as each vector processing instruction is executed by the instruction execution unit. For example, when the register width value is calculated as a function of the number of currently active threads in the computer processor in order to execute the vector processing instructions at a maximum computational throughput, the register width value may change when the number of currently active threads in the computer processor changes.

Once the register width is received in block 606, control passes to block 608 where it may be necessary to identify a portion of the variable width vector registers in the vector register file based on the received vector register width value and a currently executing thread. As mentioned, the register width value may be necessary to address the vector registers in the variable width vector register file. In addition, when vector instructions from multiple threads are executed, the vector registers in the variable width vector register file may be partitioned between the currently active threads in the computer processor and it may be necessary to identify which portion of the vector registers is used by the thread that issued the vector instruction being processed. As one skilled in the art will appreciate, this can be done through a register rename map that translates architected vector registers used by the thread (say, register A, B, C, etc.) to implemented vector registers in the vector register file (say, first register of width 128 bits, second register of width 128 bits, etc.). In general, the number of architected registers is smaller than the number of implemented registers, thus the architected vector registers of multiple threads can be mapped to different portions of the implemented vector registers to effectively share the vector register file among concurrently executing threads.

Once the necessary portion of the vector registers in the vector register file is identified in block 608, control passes to block 610 where the vector registers in the identified portion of the variable width vector register file may be accessed to obtain data for processing the received vector instruction. In one embodiment of the invention, this involves addressing the vector registers in the vector register file to read the data elements that they contain so the arithmetic or logical operation specified by the received vector processing instruction can be carried out.

Once the data from the identified portion of the vector registers is read in block 610, control passes to block 612 where the arithmetic or logical operation specified by the received vector processing instruction is applied to the data. As already mentioned, this typically involves applying the same operation to multiple data elements contained in one or more vector registers. Also, as previously mentioned, the vector processing instructions are configured to receive the necessary vector register width value dynamically as they are received and executed. Thus, the vector register width value received in block 606 is utilized in block 612 to calculate the correct number of arithmetic or logical operations to perform on the data elements in the vector register files.

As one skilled in the art would appreciate, the vector processing instructions are thus independent of the underlying vector register width and the same set of vector processing instructions can be executed on vector registers of variable width. For example, when the previously mentioned integer addition vector instruction is applied to two vector registers that are each 128 bits wide, in block 610, the illustrated method embodiment of the invention will read eight integers that are 16 bits each from each identified vector register and then, in block 612, eight addition operations will be applied to the eight corresponding pairs of integers from each register. If the vector register width is changed to 256, however, when processing the same integer addition vector instruction, 16 integers will be read from each vector register in block 610 and 16 integer addition operations will be executed in block 612.

Once processing the vector instruction is completed in block 612, control passes to block 614 where results from the processing in block 612 may be written to the portion of vector registers identified in block 608. As previously illustrated by the integer addition vector instruction, results of the arithmetic or logical operation performed on individual data elements in one or more vector registers may need to be stored into a vector register. Once this step is completed in block 614, the method illustrated in the invention embodiment in FIG. 6 terminates at block 616.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preferred embodiments to the invention has been described, it will be understood that those skilled in the art, both now and in the future, may make various improvements and enhancements which fall within the scope of the claims which follow. Thus, the claims should be construed to maintain the proper protection for the invention first described.

What is claimed is:

1. A computer processor comprising:
at least one variable width vector register file comprising a plurality of vector registers, the width of the vector registers is changeable during operation of the computer processor; and
at least one instruction execution unit coupled to the vector register file and configured to access the vector registers in the vector register file.

2. The computer processor of claim 1, further comprising:
a plurality of vector processing instructions configured to receive a register width value, the register width value indicating a necessary width of the vector registers in the vector register file in order to perform the vector processing instructions.

3. The computer processor of claim 2, wherein the instruction execution unit is further configured to:
receive the vector processing instructions and the register width value;
access a portion of the vector registers in the vector register file based on the received register width value; and
process the received vector processing instructions based on the received register width value and the accessed vector registers.

4. The computer processor of claim 3, wherein the instruction execution unit is further configured to write results of the processing of the received vector processing instructions to the portion of the vector registers in the vector register file based on the received register width value.

5. The computer processor of claim 3, further comprising a vector width register coupled to the instruction execution unit, the vector width register configured to store the register width value.

6. The computer processor of claim 5, wherein the instruction execution unit is further configured to receive the register width value from the vector width register.

7. The computer processor of claim 6, wherein the register width value stored in the vector width register is changeable during operation of the computer processor.

8. The computer processor of claim 7, wherein the register width value stored in the vector width register is computed as a function of the number of currently active threads in the computer processor in order to perform the vector processing instructions at a maximum computational throughput.

9. The computer processor of claim 1, wherein each vector register in the vector register file comprises a plurality of fixed width vector registers, the number of fixed width vector registers included in each vector register in the vector register file is changeable during operation of the computer processor.

10. The computer processor of claim 9, wherein the instruction execution unit comprises a plurality of single-instruction-multiple-data arithmetic-logic units (ALUs), each of the ALUs is coupled to a subset of the fixed width vector registers, each of the ALUs is configured to receive data from the subset of fixed width vector registers, perform arithmetic and logical functions upon the received data, and store results from the arithmetic and logical functions in the subset of fixed width vector registers.

11. A method for executing a vector processing instruction by an instruction execution unit coupled to a variable width vector register file in a computer processor, comprising:
receiving the vector processing instruction;
receiving a register width value indicating a necessary width of the vector registers in the vector register file in order to perform the vector processing instruction;
accessing a portion of the vector registers in the vector register file based on the received register width value; and
processing the received vector processing instruction based on the received register width value and the accessed vector registers.

12. The method of claim 11, wherein accessing a portion of the vector registers in the vector register file based on the received register width value comprises:
identifying the portion of the vector registers in the vector register file, the portion associated with the vector register width value and a currently executing thread; and
accessing the identified portion of the vector registers to obtain data for processing the received vector processing instruction.

13. The method of claim 11, further comprising:
writing results of the processing of the received vector processing instruction to the portion of the vector registers in the vector register file based on the received register width value.

14. The method of claim 11, wherein the register width value is received from a vector width register.

15. The method of claim 11, wherein the received register width value is computed as a function of the number of currently active threads in the computer processor in order to perform the received vector processing instruction at a maximum computational throughput

16. A computer program product embodied in a tangible media comprising:
computer readable program codes coupled to the tangible media for executing a vector processing instruction on a variable width vector register file in a computer processor, the computer readable program codes configured to cause the program to:
receive the vector processing instruction;
receive a register width value indicating a necessary width of the vector registers in the vector register file in order to perform the vector processing instruction;
access a portion of the vector registers in the vector register file based on the received register width value; and
process the received vector processing instruction based on the received register width value and the accessed vector registers.

17. The computer program product of claim 16, wherein the computer readable program code to access a portion of the vector registers in the vector register file based on the received register width value comprises computer readable program code to:
identify the portion of the vector registers in the vector register file, the portion associated with the vector register width value and a currently executing thread; and
access the identified portion of the vector registers to obtain data for processing the received vector processing instruction.

18. The computer program product of claim 16, further comprising computer readable program code configured to:
write results of the processing of the received vector processing instruction to the portion of the vector registers in the vector register file based on the received register width value.

19. The computer program product of claim 16, wherein the computer readable program code to receive a register width value indicating a necessary width of the vector registers in the vector register file in order to perform the vector processing instruction comprises computer readable program code to:
read the register width value from a vector width register.

20. The computer program product of claim 16, further comprising computer readable program code configured to:
compute the received register width value as a function of the number of currently active threads in the computer processor in order to perform the received vector processing instruction at a maximum computational throughput.
